(19) United States
(12) Patent Application Publication
(10) Pub. No.: US 2013/0078486 A1
(43) Pub. Date: Mar. 28, 2013

(54) POWER SUPPLY DEVICE

(71) Applicants: Po-Kuei Chou, Hsinchu County (TW); Chien-Hsun Yang, Hsinchu County (TW); Yueh-Chang Wu, Hsinchu County (TW); Wen-Hsin Chang, Hsinchu County (TW); Yu-Hsiang Lin, Hsinchu County (TW)

(72) Inventors: Po-Kuei Chou, Hsinchu County (TW); Chien-Hsun Yang, Hsinchu County (TW); Yueh-Chang Wu, Hsinchu County (TW); Wen-Hsin Chang, Hsinchu County (TW); Yu-Hsiang Lin, Hsinchu County (TW)

(73) Assignee: YOUNG GREEN ENERGY CO., Hsinchu County (TW)

(21) Appl. No.: 13/523,834

(22) Filed: Jun. 14, 2012

(30) Foreign Application Priority Data
Sep. 23, 2011 (CN) 201110291596.1

(51) Int. Cl. H01M 16/00; H01M 10/50; H01M 8/04

(52) U.S. Cl. 429/9

(57) ABSTRACT

A power supply device includes a first case, a second case, a battery module, an air suction element, and a heat exchange module. The first case includes an air hole. The second case is disposed in the first case, and the second case includes a fuel cell therein. The battery module is disposed in the first case. The fuel cell and the battery module supply power to each other. The air suction element is disposed in the first case and near the air hole, and sucks an air into the first case through the air hole. The heat exchange module is disposed in the first case for heating the air. The air is warmed up after flowing by the heat exchange module, and at least a part of the air flows by the fuel cell and the battery module.

### CROSS-REFERENCE TO RELATED APPLICATION

This application claims the priority benefit of China application serial no. 201110291596.1, filed on Sep. 23, 2011. The entirety of the above-mentioned patent application is hereby incorporated by reference herein and made a part of this specification.

### BACKGROUND OF THE INVENTION

1. Field of the Invention

The invention relates to a power supply device, in particular, to a power supply device using a fuel cell.

2. Description of Related Art

The fuel cell (FC) is a power generating device which coverts chemical energy into electric energy. Compared with conventional power generating methods, the fuel cell has advantages such as low pollution, low noise, high energy density, and relatively high energy conversion efficiency, and is a clean energy source with a promising future. The fuel cell could be applied in various fields, including portable electronic products, home power generating systems, transportation vehicles, military facilities, aerospace industry, and small power generating systems.

Different fuel cells are applied in different markets considering their working principles and operating environments. Among others, the proton exchange membrane fuel cell (PEMFC) and direct methanol fuel cell (DMFC) are mainly used as movable power sources. The two types of fuel cells both use proton exchange membranes to implement the proton conduction mechanism, and are fuel cells that could be started at a low temperature. The operating principle of the PEMFC is as follows: when hydrogen is oxidized on an anode catalyst layer, hydrogen ions (H+) and electrons (e−) are produced (the PEMFC principle). Alternatively, methanol and water undergo oxidation on an anode catalyst layer, hydrogen ions (H+), carbon dioxide (CO2) and electrons (e−) are produced (the DMFC principle). The hydrogen ions are transmitted to a cathode by a proton conduction film, and the electrons are transferred to a load by an external circuit, perform work, and then transmitted to the cathode. At this time, oxygen supplied to the cathode end and the hydrogen ions and electrons undergo reduction on a cathode catalyst layer, and water is produced.

Because water is produced during the reaction in the fuel cell, if the fuel cell is started or operated at a temperature below the freezing point of water(for example, in a low temperature environment such as high mountains or polar areas where the temperature is lower than 0° C.), ice may form on the surface of the proton exchange membrane. In this case, the proton exchange membrane may be pierced by the ice and damaged. In addition, if the reactant for producing hydrogen in the fuel cell is water, as the water turns into ice at the at a temperature below the freezing point of water, the reactant could not react with other reactants to produce hydrogen.

A fuel cell module is disclosed in Taiwan Patent No. TW 1255577, in which a fan is used to introduce hot air to a cathode end of the fuel cell. A heat generator is disclosed in US Patent Application Publication No. U.S. 20090253092, there are a burner, a heat exchanger, and a fuel cell assembly are accommodated in an enclosure of the heat generator. A fuel cell system is disclosed in US Patent No. U.S. Pat. No. 7,470,479, in which air is warmed up by a heat exchanger is guided to a fuel cell. A fuel cell is disclosed in U.S. Patent Application Publication No. U.S. 20080118787, in which a top cover is used for warming up a coolant within a coolant header.

### SUMMARY OF THE INVENTION

Accordingly, the invention is directed to a power supply device, which has a fuel cell capable of operating normally at a temperature below the freezing point of water.

Other objectives and advantages of the invention will be better understood with reference to technical features disclosed by the invention.

To achieve one of, a part of, or all of the above objectives or other objectives, an embodiment of the invention provides a power supply device, which includes a first case, a second case, a battery module, an air suction element, and a heat exchange module. The first case includes an air hole. The second case is disposed in the first case, and the second case includes a fuel cell therein. The battery module is disposed in the first case. The fuel cell and the battery module supply power to each other. The air suction element is disposed in the first case and near the air hole, and sucks an air into the first case through the air hole. The heat exchange module is disposed in the first case for warming up the air. The air is warmed up after flowing through the heat exchange module, and at least a part of the air flows by the fuel cell and the battery module.

As described above, in the embodiments of the invention, the air is warmed up by the heat exchange module flows by the fuel cell and the battery module, so that the fuel cell and the battery module supply power at a relatively high temperature. In this way, the problem that ice is formed in the fuel cell and affects the normal operation of the fuel cell is prevented, and the battery module achieves higher power supply efficiency because of the relatively high temperature. Therefore, the power supply device could supply power normally at a temperature below the freezing point of water such as high mountains and polar areas.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a power supply device according to an embodiment of the invention.

FIG. 2 is a schematic view of air flowing in the power supply device shown in FIG. 1.

FIG. 3 is a schematic view of a heat exchange module according to another embodiment of the invention.

FIG. 4 is a schematic view of a heat exchange module according to still another embodiment of the invention.

FIG. 5 is a schematic view of a heat exchange module according to yet another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

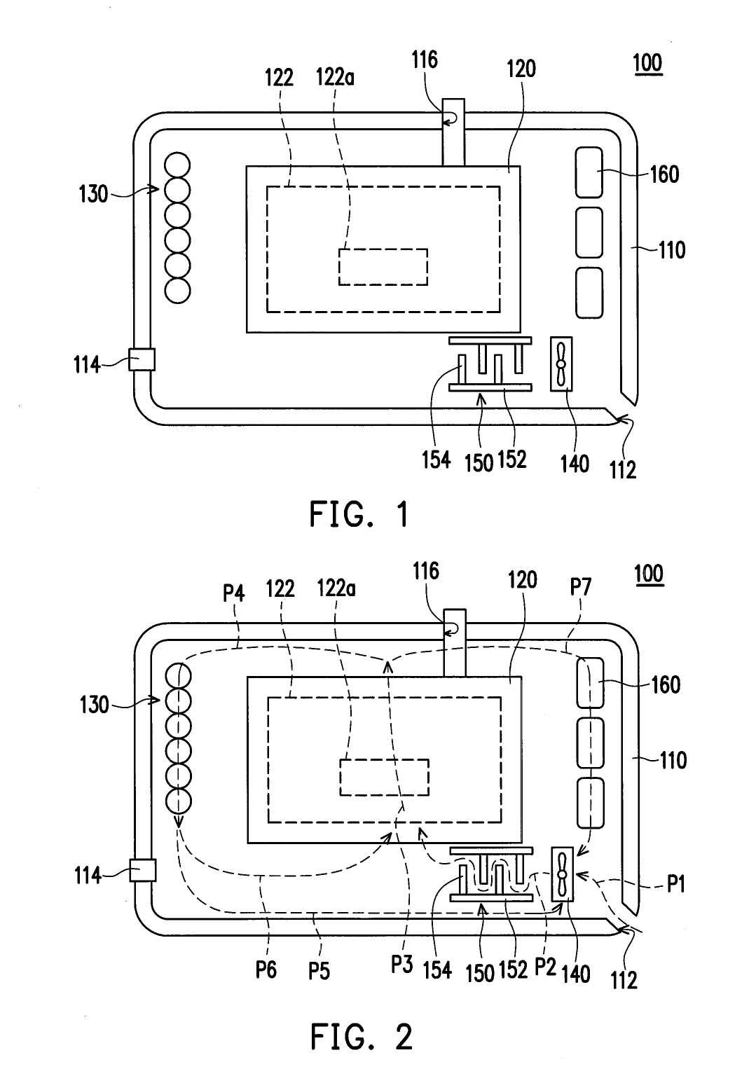

FIG. 1 is a schematic view of a power supply device according to an embodiment of the invention. FIG. 2 is a schematic view of air flowing in the power supply device shown in FIG. 1. Referring to FIGS. 1 and 2, the power supply device 100 according to this embodiment includes a first case 110, a second case 120, a battery module 130, an air suction element 140 and a heat exchange module 150. The first case 110 includes an air hole 112. The second case 120 is disposed in the first case 110, and the second case 120 includes a fuel cell 122 therein. The battery module 130 is disposed in the first case 110. The battery module 130 supplies power to the fuel cell 122 to provide the power required for an initial operation of the fuel cell 122. After the fuel cell 122 undergoes a reaction and generates electric power, the fuel cell 122 also supplies power to the battery module 130 so that the battery module 130 could maintain enough capacity.

The air suction element 140 is for example a fan, and is disposed in the first case 110 and near the air hole 112. The air suction element 140 sucks air (for example, the air from the external environment) into the first case 110 along a path P1 through the air hole 112. The first case 110 is not closely attached on the second case 120 in this embodiment, a space exists between the first case 110 and the second case 120 and serves as a passage for air flowing, the air entering the first case 110 could flow between the first case 110 and the second case 120. The heat exchange module 150 is disposed in the first case 110. When the air flows by the heat exchange module 150 along a path P2 and is warmed up, a part of the air flows by the fuel cell 122 along a path P3, then flows by the battery module 130 along a path P4, and finally flows to the air suction element 140 along a path P5, and then flows on.

In the above disposing manner, after the air is warmed up by the heat exchange module 150, the air flows by the fuel cell 122, the battery module 130 and the air suction element 140 sequentially, so that the fuel cell 122 and the battery module 130 supply power in an environment where the temperature is relatively high. The air is cyclically warmed up because of the operation of the air suction element 140, which ensures that the internal of the power supply device 100 is not at the temperature below the freezing temperature of water. In this way, the problem that ice is formed in the fuel cell 122 and affects the normal operation of the fuel cell 122 is prevented, and the battery module 130 achieves higher power supply efficiency because of the relatively high temperature. Therefore, the power supply device 100 could supply power normally at the temperature below the freezing temperature of water such as high mountains and polar areas.

In the invention, the temperature rising range in the first case 110 and the second case 120 is not limited. For example, in order to prevent the ice forming in the fuel cell 122, the heat exchange module 150 needs to warm up the air to a sufficient high temperature, so that the temperature in the first case 110 and the second case 120 rises from the temperature below the freezing temperature of water (0° C.). to the temperature above the freezing temperature of water(0° C.). To further improve the power supply efficiency of the fuel cell 122 and the battery module 130, the heat exchange module 150 could warm up the air to a high temperature, so that the temperature in the first case 110 and the second case 120 rises to 5° C. or above another threshold temperature. In addition, the air flowing manner is not limited in the invention. After the air flows by the battery module 130 along the path P4, a part of the air may enter the second case 120 along a path P6, and then flows out of the second case 120 along the path P3.

In particular, the material of the first case 110 according to this embodiment includes a thermal insulation material such as foam and styrofoam, so that the temperature in the first case 110 does not drop rapidly when the temperature of the external environment is low. In other embodiments, a vacuum layer may also be disposed in the first case 110 to reduce the speed of heat exchange with the external environment, so as to further prevent the rapid temperature drop in the first case 110 when the temperature of the external environment is low.

In addition, the first case 110 according to this embodiment includes an air relief valve 114. The air in the first case 110 may be discharged to the external environment through the air relief valve 114, so as to adjust the air pressure in the first case 110, and prevent the problem that it is hard for the air suction element 140 to suck an air from the external environment (such as the air) into the first case 110 because the pressure in the first case 110 is too high. In addition, the first case 110 further includes an air discharge port 116. The air discharge port 116 is in communication with the second case 120, and the residual air after reaction of the fuel cell 122 may be discharged to the external environment through the air discharge port 116. In other embodiments, the first case 110 may also use the air discharge port instead of the air relief valve 114 at the position where the air relief valve 114 is disposed, and an air permeable and liquid impermeable membrane may further be disposed on the air discharge port to prevent external liquid from entering the power supply device 100 and affecting normal operation of the power supply device 100.

As shown in FIGS. 1 and 2, the heat exchange module 150 according to this embodiment includes two heating plates 152 and a plurality of partition boards 154. The partition boards 154 are disposed between the two heating plates 152, so as to form a flow passage between the two heating plates 152. The air flows through the flow passage along the path P2 and is sufficiently warmed up by the two heating plates 152. However, the invention is not limited by FIGS. 1 and 2. In other embodiments, the heat exchange module may include one or more heating plates, and the plurality of partition boards may be disposed on one side or two sides of the heating plates according to actual needs. This is illustrated in the following with reference to the drawings.

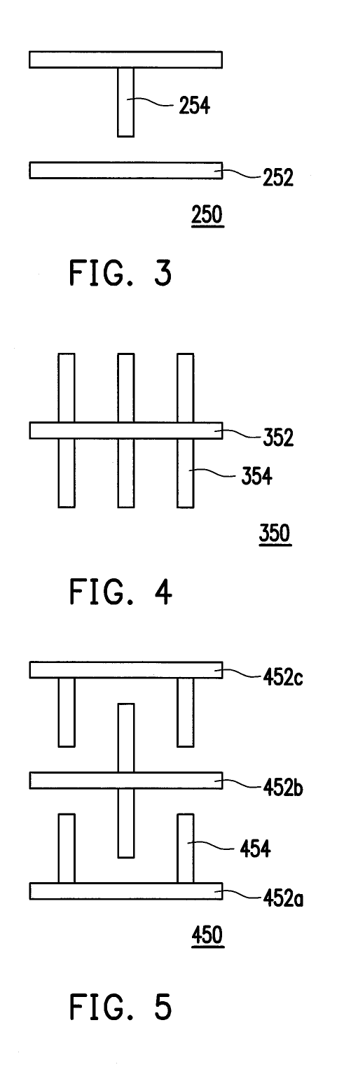

FIG. 3 is a schematic view of a heat exchange module according to another embodiment of the invention. Referring to FIG. 3, the heat exchange module 250 according to this embodiment includes two heating plates 252 and one partition board 254, and the partition board 254 is disposed between the two heating plates 252, so as to form a flow passage between the two heating plates 252.

FIG. 4 is a schematic view of a heat exchange module according to still another embodiment of the invention. Referring to FIG. 4, the heat exchange module 350 according to this embodiment includes one heating plate 352 and a plurality of partition boards 354. A part of the partition boards 354 are disposed on one side of the heating plate 352, and other partition boards 354 are disposed on the other side of the heating plate 352, so as to form a flow passage on two sides of the heating plate 352.

FIG. 5 is a schematic view of a heat exchange module according to yet another embodiment of the invention. Referring to FIG. 5, the heat exchange module 450 according to this embodiment includes three heating plates 452a-452c and a plurality of partition boards 454. A part of the partition boards 454 are disposed between the heating plate 452a and the heating plate 452b, so as to form a flow passage between the heating plate 452a and the heating plate 452b. Other partition boards 454 are disposed between the heating plate 452b and the heating plate 452c, so as to form a flow passage between the heating plate 452b and the heating plate 452c.

As shown in FIG. 2, the fuel cell 122 according to this embodiment includes a heat generating element 122a. During the reaction of the fuel cell 122, the heat generating element 122a generates heat, and the air is further warmed up when the air flows by the heat generating element 122a along the path P3, so as to increase the temperature in the power supply device 100 by using the heat generated from operating the fuel cell 122.

The fuel cell 122 according to this embodiment is for example a proton exchange membrane fuel cell (PEMFC), a direct methanol fuel cell (DMFC), or a solid oxide fuel cell (SOFC), and the type of the fuel cell 122 is not limited in the invention. Moreover, the battery module according to this embodiment may include a lithium ion battery, a LiFePO4 battery, a lead-acid battery, a nickel-metal hydride battery, or a dry battery.

As shown in FIG. 2, the power supply device 100 according to this embodiment further includes at least one fuel storage tank 160 (there are three in FIG. 2). The fuel storage tanks 160 are disposed in the first case 110 for providing the fuel required by the reaction of the fuel cell 120. For example, the fuel storage tanks 160 are hydrogen storage tanks, for storing the hydrogen gas or reactants for generating hydrogen required by the reaction of the fuel cell 120. After the air flows out of the second case 120 along the path P3, a part of the air flows by the fuel storage tanks 160 along a path P7 and reaches the air suction element 140. The air flowing by the fuel storage tanks 160 increases the temperature of the fuel storage tanks 160, so that the fuel supplied by the fuel storage tanks 160 to the fuel cell 122 is at a relatively high temperature. In this way, the reaction efficiency of the fuel cell 122 is improved.

In the invention, the positions of the components in the first case 110 are not limited. Relative positions of the second case 120, the battery module 130, the air suction element 140, the heat exchange module 150 and the fuel storage tank 160 may be properly arranged, and an appropriate number of baffles or other air flow guiding structures may be disposed at appropriate positions in the first case 110, so that the air cyclically flows in the first case 110 because of the operation of the air suction element 140.

To sum up, in the above embodiment of the invention, the air warmed up by the heat exchange module flows by the fuel cell, the battery module, the fuel storage tank, and the air suction element, so that the fuel cell and the battery module supply power at a relatively high temperature, and the air is cyclically warmed up because of the operation of the air suction element, which ensures that the internal of the power supply device is not in the temperature below the freezing temperature of water. In this way, the problem that ice is produced in the fuel cell and affects the normal operation of the fuel cell is prevented, and the battery module achieves higher power supply efficiency because of the relatively high temperature. Moreover, the fuel supplied by the fuel storage tank to the fuel cell is at a relatively high temperature to improve the reaction efficiency of the fuel cell. Therefore, the power supply device could supply power normally in below freezing environment such as high mountains and polar areas.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc.

following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A power supply device, comprising:
a first case, comprising an air hole;
a second case, disposed in the first case, wherein the second case comprises a fuel cell therein;
a battery module, disposed in the first case, wherein the fuel cell and the battery module supply power to each other;
an air suction element, disposed in the first case and near the air hole, wherein the air suction element sucks an air into the first case through the air hole; and
a heat exchange module, disposed in the first case for warming up the air, wherein after the air flows by the heat exchange module and is warmed up, at least a part of the air flows by the fuel cell and the battery module.

2. The power supply device according to claim 1, further comprising a passage, wherein the passage is formed between the first case and the second case, and the air flows by the heat exchange module, the fuel cell, and the battery module through the passage.

3. The power supply device according to claim 1, wherein the first case comprises an air relief valve, and the air in the first case is discharged to the external environment through the air relief valve to adjust an air pressure in the first case.

4. The power supply device according to claim 1, wherein the first case comprises an air discharge port, the air discharge port is in communication with the second case, and the residual air after a reaction of the fuel cell is discharged to the external environment through the air discharge port.

5. The power supply device according to claim 1, wherein the material of the first case comprises a thermal insulation material.

6. The power supply device according to claim 1, wherein the fuel cell is a proton exchange membrane fuel cell, a direct methanol fuel cell, or a solid oxide fuel cell.

7. The power supply device according to claim 1, wherein the fuel cell comprises a heat generating element, and the air flows by the heat generating element and is warmed up.

8. The power supply device according to claim 1, wherein the battery module comprises a lithium ion battery, a LiFePO4 battery, a lead-acid battery, a nickel-metal hydride battery, or a dry battery.

9. The power supply device according to claim 1, wherein the air suction element is a fan.

10. The power supply device according to claim 1, wherein the heat exchange module comprises:
at least one heating plate; and
at least one partition board, wherein the partition board forms a flow passage, and the air flows through the flow passage and is warmed up by the at least one heating plate.

11. The power supply device according to claim 10, wherein the number of the at least one heating plate is two, and the at least one partition board is disposed between the two heating plates.

12. The power supply device according to claim 1, further comprising at least one fuel storage tank, wherein the fuel storage tank is disposed in the first case for providing a fuel required by a reaction of the fuel cell.

13. The power supply device according to claim 12, wherein the fuel storage tank is a hydrogen storage tank.

14. The power supply device according to claim 12, wherein after the air is warmed up by the heat exchange module, a part of the air flows by the fuel cell, the fuel storage tank, and the air suction element.
